(19) United States
(12) Patent Application Publication
(10) Pub. No.: US 2024/0354626 A1
(43) Pub. Date: Oct. 24, 2024

(54) Operating Quantum Devices Using Unsupervised Learning

(71) Applicant: Google LLC, Mountain View, CA (US)

(72) Inventors: Paul Victor Klimov, Santa Barbara, CA (US); Trond Ikdahl Andersen, Santa Monica, CA (US); Yuezhen Niu, Los Angeles, CA (US); Vadim Smelyanskiy, Mountain View, CA (US)

(21) Appl. No.: 18/156,063

(22) Filed: Jan. 18, 2023

(51) Int. Cl. G06N 10/60; G06N 10/40

(52) U.S. Cl. CPC G06N 10/60; G06N 10/40

(57) ABSTRACT

Systems and methods for operating a quantum computing system are provided. In some examples, a method may include obtaining characterization data associated with an operating parameter of a qubit in a quantum computing system. The method may include implementing an unsupervised learning operation to extract one or more anomalies from the characterization data. The method may include operating the qubit in the quantum computing system based at least in part on the one or more anomalies.

### FIELD

The present disclosure relates generally to quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems may manipulate information using quantum bits (“qubits”). A qubit may refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b |1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or may be learned from the description, or may be learned through practice of the embodiments.

One example aspect of the present disclosure is directed to a method of operating a quantum computing system. The method may include obtaining characterization data associated with an operating parameter of a qubit in a quantum computing system. The method may include implementing an unsupervised learning operation to extract one or more anomalies from the characterization data. The method may include operating the qubit in the quantum computing system based at least in part on the one or more anomalies.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2 depicts an example plot of qubit operating frequency versus energy relaxation time.

FIG. 3 depicts example qubit characterization data according to example embodiments of the present disclosure;

FIG. 4 depicts a flow chart of an example method for operating a quantum computing system according to example embodiments of the present disclosure;

FIGS. 5A and 5B depict example pre-processing of qubit characterization data according to example embodiments of the present disclosure;

FIG. 6 depicts an example unsupervised learning operation on qubit characterization data according to example embodiments of the present disclosure;

FIG. 7 depicts example extraction of predicted future anomalies according to example embodiments of the present disclosure;

FIG. 8 depicts a flow chart of an example method for operating a qubit in a quantum computing system according to example embodiments of the present disclosure;

FIG. 9 depicts a flow chart of an example method of determining an operating parameter for a qubit according to example embodiments of the present disclosure; and

FIG. 10 depicts an example computing environment that may be used to implement example embodiments of the present disclosure.

### DETAILED DESCRIPTION

Example aspects of the present disclosure are directed to systems and methods for operating qubits in a quantum computing system. One problem with operating quantum computing systems is that qubits may decohere (e.g., dephase and/or transition between states undesirably). Decoherence occurring before completing a calculation may lead to errors.

For instance, quantum computing devices may include a quantum processor(s) having a plurality of qubits (e.g., superconducting qubits). Each qubit may be operated according to an operating parameter. The effectiveness of the operating parameter may be dependent on properties associated with the qubit. The properties may vary as a function of the operating parameter and may vary over time. In some cases, the property variations may lead to anomalies resulting from, for instance, colliding or coinciding with two-level-system (TLS) defects in the materials used to implement the plurality of qubits.

For example, a quantum processor(s) may include a plurality of superconducting qubits arranged, for instance, in a two-dimensional grid, where neighboring qubits are allowed to interact. Each qubit may be operated using respective operating frequencies (e.g., respective idling frequency and/or interaction frequencies and/or readout frequencies and/or reset frequencies). The operating frequencies may vary from qubit to qubit (e.g., each qubit may idle at a different operating frequency). Some operating frequencies are better than other operating frequencies. A metric for assessing a particular operating frequency for a qubit may be energy relaxation time for the operating frequency. Lower energy relaxation times may lead to larger quantum computational errors, so it may be desirable to operate qubits at frequencies where energy relaxation time is high.

However, qubit energy relaxation times may fluctuate by orders of magnitude based on operating frequency and based on time. In this regard, time-based fluctuations in energy relaxation times may present an obstacle for scaling quantum computers. Some fluctuations in energy relaxation times may be caused by transitions of material TLS defects colliding (e.g., moving into and out of resonance) or coinciding with qubit transitions. In some cases, the fluctuations may exhibit telegraphic behavior, in which the anomaly frequency moves between multiple discrete states. Alternatively, the fluctuations may exhibit diffusive behavior, in which the anomaly drifts semi-continuously. In yet another form, the anomaly might exhibit some of each of the telegraphic and diffusive behaviors. In frequency tunable qubit architectures, errors associated with TLS defects may be reduced by optimizing frequencies at which quantum operations (e.g., single-qubit gates, multijubit gates, reset and readout) happen.

Automatically determining anomalies in qubit characterization data (e.g., energy relaxation time versus operating frequency versus time) in a quantum computing system may be useful for the design and operation of quantum computing systems. However, realizing anomaly detection that is compatible with scaled up quantum computing systems (e.g., quantum computing systems with hundreds of qubits or more, such as thousands of qubits or more, such as millions of qubits or more) is non-trivial due to several factors. For instance, it may be desirable for anomaly detection to be capable of identifying complex patterns in the qubit characterization data, preferably without a large volume of labeled training data (e.g., without human supervision). Moreover, the anomaly detection may need to be fast enough for deployment into existing qubit characterization and calibration methods.

Aspects of the present disclosure describe systems and methods that leverage unsupervised learning operations to implement anomaly detection and operation of quantum computing devices based at least in part on such anomaly detection. In one example, the systems and methods may obtain characterization data associated with one or more qubits in a quantum computing system. As an example, the characterization data may be historical energy relaxation time versus frequency for the one or more qubits.

In some examples, the systems and methods may pre-process the characterization data. The pre-processing of the characterization data may include, for instance, inverting energy relaxation time data to obtain energy relaxation rate data. The pre-processing of the characterization data may include applying a smoothing filter, for instance, in time and/or in frequency. The pre-processing of the characterization data may include identifying data points (e.g., peaks) in the characterization data that exceed a defined threshold value.

According to example aspects of the present disclosure, an unsupervised learning operation may be implemented on the characterization data (e.g., the pre-processed characterization data) to extract anomalies and/or predicted future anomalies from the characterization data. As used herein, an unsupervised learning operation refers to an operation that may extract a pattern from data that has not been tagged or labeled. In some examples, the unsupervised learning operation may be a clustering operation, such as a density-based clustering operation and/or a spectral-based clustering operation. Other unsupervised learning operations may be used, in some applications, without deviating from the scope of the present disclosure, such as k-means clustering operations (e.g., to identify circular anomalies), expectation-maximization operations (e.g., to identify elliptical anomalies), or other clustering operations.

The systems and methods according to example aspects of the present disclosure may operate the quantum computing system (e.g., operate a qubit of the quantum computing system) based at least in part on the extracted anomalies determined using the unsupervised learning operation. For instance, qubits of the quantum computing system may be calibrated and/or operated (e.g., during implementation of a quantum operation) based on an operating parameter selected to avoid an anomaly or a future predicted anomaly. In some examples, the anomalies data may be analyzed to determine properties of the anomalies (e.g., density, diffusivity, velocity, acceleration, etc.). In some examples, one or more quantum hardware parameters may be modified (e.g., during design, fabrication, material selection, etc.) based at least in part on the extracted anomalies. In some examples, one or more environmental parameters (e.g., temperature, vibrations, magnetic field, control electronics) may be modified based at least in part on the extracted anomalies.

In some embodiments, one or more control devices that form a part of quantum computing device and that send control signals to qubits to implement quantum operation(s) (e.g., quantum gates, state preparation, and/or readout) may monitor for anomalies using the anomaly detection methods provided in the present disclosure. The control devices may modify operating parameters of the qubits (e.g., operating frequency) to perform a quantum operation based on detected anomalies and/or future predicted anomalies (e.g., predicted collisions with two-level-system defects) to reduce the likelihood of errors (e.g., errors due to TLS defects).

The systems and methods according to example aspects of the present disclosure may provide a number of technical effects and benefits and may provide an improvement to quantum computing technology. For instance, each of the operations may be parallelizable, which increases scalability of anomaly detection for quantum computing systems with a plurality of qubits (e.g., hundreds of qubits or more, such as thousands of qubits or more, such as millions of qubits or more). Anomalies may be detected and/or predicted in time and/or in space without labeled data and/or physics models. The use of unsupervised learning operations according to example aspects of the present disclosure does not require large amounts of labeled training data. This particularly beneficial because many realistic anomalies are irregular, random, and/or unknown before detection, making it difficult to construct representative training data sets.

Using unsupervised learning operations to extract anomalies according to example aspects of the present disclosure may be implemented relatively fast either serially and/or in parallel without human supervision. For instance, O(100) anomalies may be detected for O(10) qubits in seconds, with zero human intervention, indicating suitability for implementation in qubit calibration and characterization methods.

Aspects of the present disclosure are discussed with reference to superconducting qubits for purposes of illustration and discussion. Those of ordinary skill in the art, using the disclosure provided here, will understand that the systems and methods may be implemented with other types of qubit architectures, such as qubits architectures based on spins, photons, ions, neutral-atoms, quantum-dots, molecules, or other suitable quantum phenomena.

Aspects of the present disclosure are discussed with reference to characterization data that includes energy relaxation time of a qubit for purposes of illustration and discussion. Those of ordinary skill in the art, using the disclosures provided herein, will understand that the characterization data may include other qubit-state information or measurement of system performance, such as measurement of system performance versus control parameters (e.g., voltage), delay times between state preparation and measurement, operating frequency, electromagnetic field values, operating temperatures, etc. In some examples, the characterization data may include or be based on quantum processor micrographics and/or photographs and/or scanning-electron-microscope (SEM) images of the qubit(s).

Aspects of the present disclosure are discussed with reference to anomalies corresponding to TLS defects for purposes of illustration and discussion. Those of ordinary skill in the art, using the disclosures provided herein, will understand that the anomalies may be based on or correspond with other defects, noise, artifacts, and/or errors. For instance, in some examples, the anomalies may correspond to masking artifacts and/or spurious noise due to control hardware errors and/or noise in operating and/or environmental parameters. In some examples, the anomalies may correspond to physical artifacts due to phenomena that are not well controlled and/or understood and/or expected. In some examples, the anomalies may correspond to hardware design and/or fabrication imperfections.

With reference now to the FIGS., example embodiments of the present disclosure will be discussed in further detail. As used here, the use of the term “about” in conjunction with a value refers to within 20% of the value.

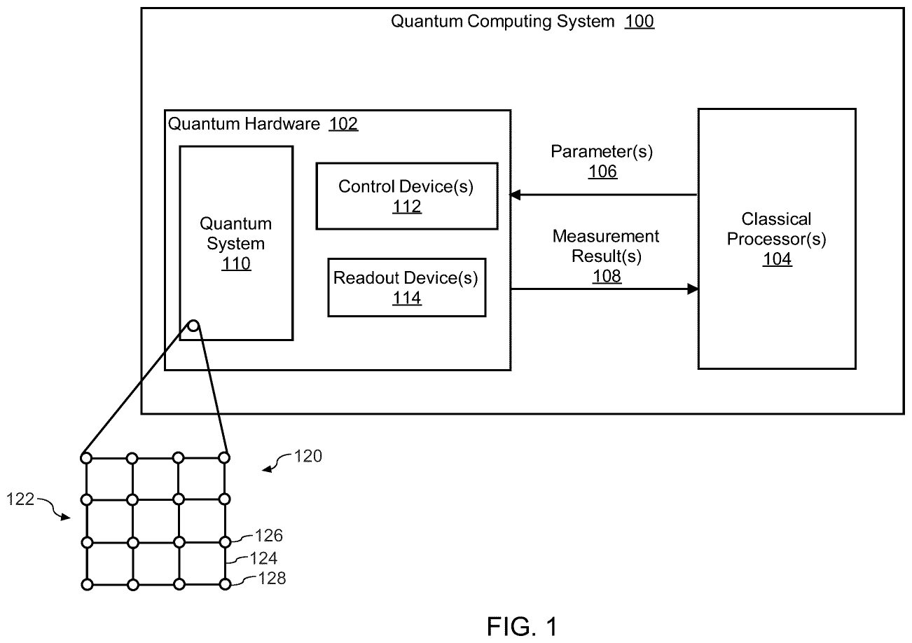

FIG. 1 depicts an example quantum computing system 100. The system 100 is an example of a system of one or more classical computers and/or quantum computing devices in one or more locations, in which the systems, components, and techniques described below may be implemented. Those of ordinary skill in the art, using the disclosures provided herein, will understand that other quantum computing devices or systems may be used without deviating from the scope of the present disclosure.

The system 100 includes quantum hardware 102 in data communication with one or more classical processors 104. The classical processors 104 may be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 may include one or more multi-level quantum subsystems, such as a register of qubits (e.g., qubits 120). In some implementations, the multi-level quantum subsystems may include superconducting qubits, such as flux qubits, charge qubits, transmon qubits, gmon qubits, etc.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits may be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 may take advantage of a difference in the impedance for the |0 [symbol] and |1 [symbol] states of an element of the quantum system, such as a qubit, to measure the state of the element (e.g., the qubit). For example, the resonance frequency of a readout resonator may take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter may be used in conjunction with the readout device(s) 114 to impede microwave propagation at the qubit frequency.

In some embodiments, the quantum system 110 may include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 may interact with each other through multiple qubit couplers, e.g., qubit coupler 124. The qubit couplers may define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 may be operated using respective operating frequencies, such as an idling frequency and/or an interaction frequency and/or readout frequency and/or reset frequency. The operating frequencies may vary from qubit to qubit. For instance, each qubit may idle at a different operating frequency. The operating frequencies for the qubits 120 may be chosen before a computation is performed.

Some operating frequencies are better than other operating frequencies. One metric for assessing how good a particular operating frequency is for a particular qubit is energy relaxation time (T1) for the qubit at the frequency. Lower energy relaxation times may lead to larger quantum computational errors. In that regard, it may be desirable to operate qubits at frequencies where energy relaxation time is high.

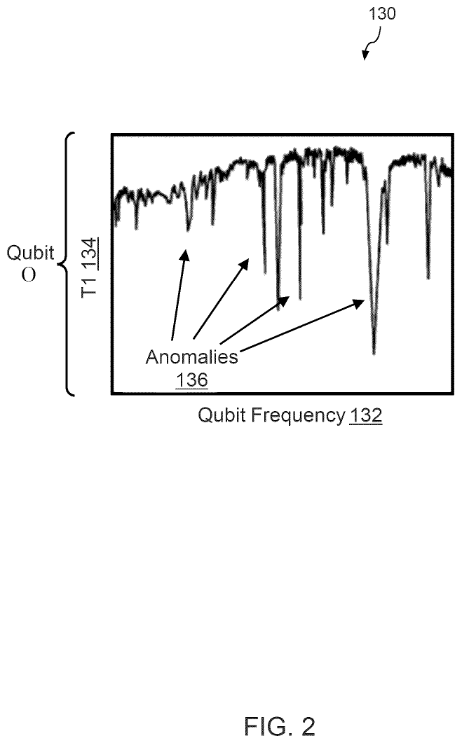

FIG. 2 depicts a plot 130 showing an example relationship between qubit frequency 132 and energy relaxation time (T1) 134. FIG. 2 plots qubit frequency 132 along the horizontal axis and plots energy relaxation time (T1) 134 along the vertical axis. Ideally, energy relaxation time 134 would vary smoothly as a function of qubit frequency. However, as shown in plot 130, in reality energy relaxation time 134 may vary sporadically as a function of qubit frequency due to anomalies, as demonstrated by the downward spikes 136. The anomaly may be attributable to, for instance, a TLS defect transition frequency moving into resonance with the operating frequency.

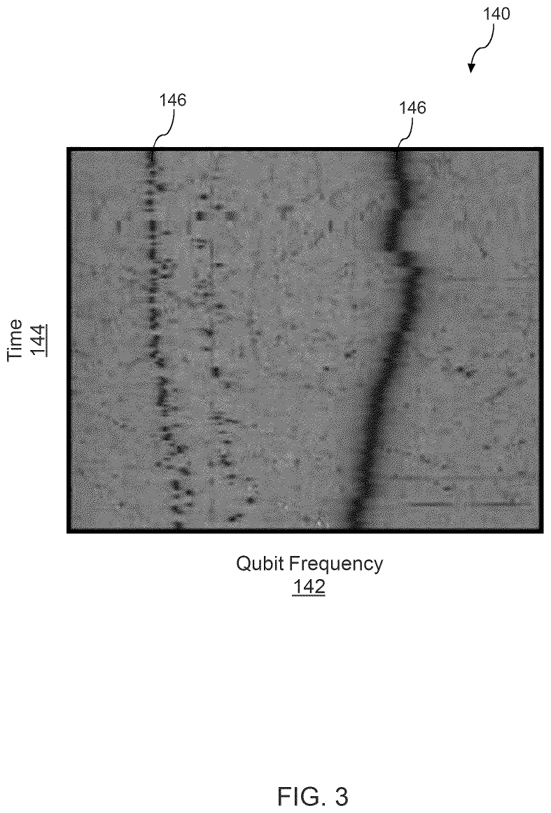

Energy relaxation time may also vary over time. For instance, FIG. 3 depicts characterization data 140 as a plot of energy relaxation time (T1) as a function of operating frequency 142 and time 144. FIG. 3 plots energy operating frequency 142 along the horizontal axis and time 144 along the vertical axis. The pixel color/shading of the plot 140 represents the energy relaxation time at each operating frequency 142 and time 144. The darker pixels 146 in the plot 140 represent reductions in energy relaxation time that may be attributable to anomalies, such as collisions with TLS defects. As shown, the operating frequency at which the anomalies occur may vary over time and exhibit a time dependent behavior.

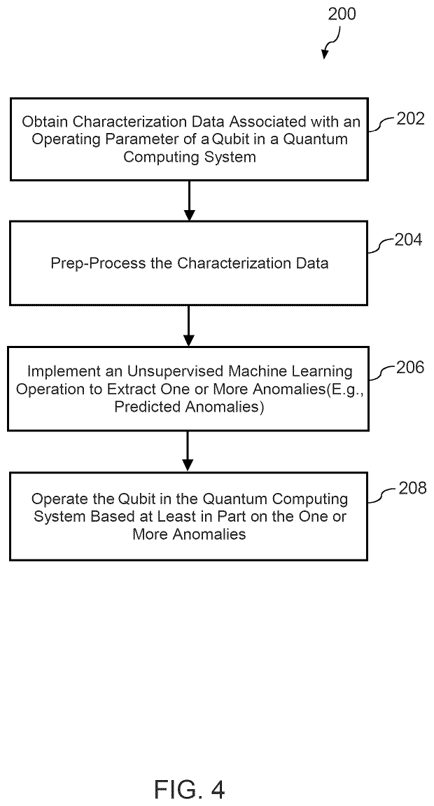

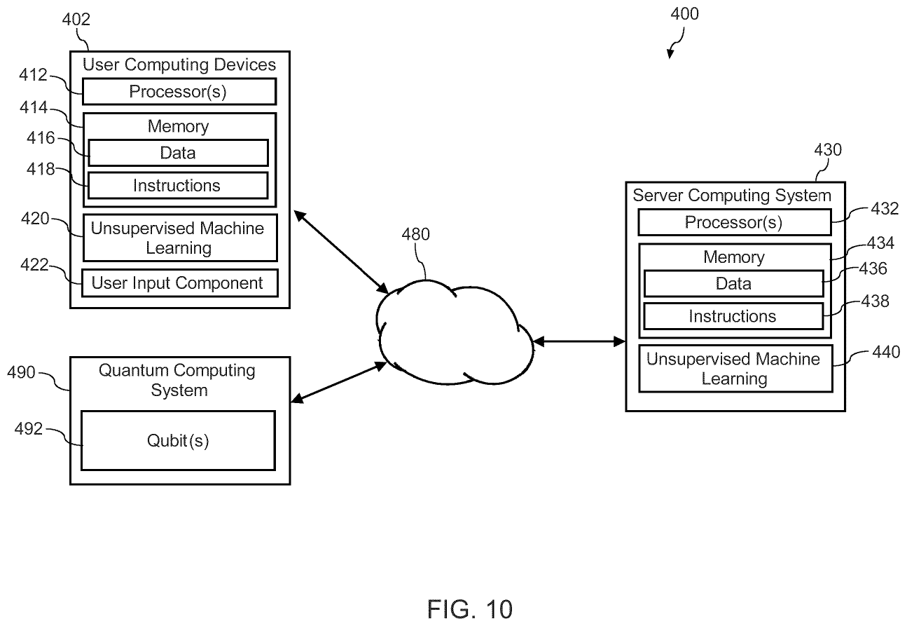

FIG. 4 depicts a flow diagram of an example method 200 for operating one or more qubits in a quantum computing system according to example embodiments of the present disclosure. The method 200 may be implemented using any suitable quantum and/or classical computing systems, such as the system described in FIG. 1 and/or in FIG. 10. FIG. 4 depicts operations performed in a particular order for purposes of illustration and discussion. Those of ordinary skill in the art, using the disclosures provided herein, will understand that operations of any of the methods described herein may be expanded, include steps not illustrated, omitted, rearranged, and/or modified in various ways without deviating from the scope of the present disclosure.

At 202, the method 200 includes obtaining characterization data associated with an operating parameter of a qubit in a quantum system. In some embodiments, the characterization data may be associated with energy relaxation time at different operating frequencies associated with the qubit. The operating frequencies may be, for instance, idling frequencies and/or interaction frequencies at which to operate nearest-neighbor interacting qubits in a network of interacting qubits. An example of characterization data associated with energy relaxation time is provided in FIG. 3.

At 204, the method 200 includes pre-processing the characterization data. Pre-processing the characterization data may facilitate future operations, such as implementation of an unsupervised learning operation according to example embodiments of the present disclosure. In this regard, pre-processing the characterization data may occur prior to implementation of an unsupervised learning operation.

Pre-processing the data may include any processing that facilitates implementation of an unsupervised learning algorithm without deviating from the scope of the present disclosure. Certain types of data representation may undergo different pre-processing operations. For instance, in some examples, pre-processing the characterization data may include applying a filter to the characterization data. In some examples, pre-processing the characterization data may include applying a smoothing operation to the characterization data.

In some examples, pre-processing the characterization data may include inverting the characterization data. For instance, in the example, where characterization data is energy relaxation time versus frequency and time, inverting the characterization data may yield energy relaxation rate versus frequency and time. More particularly, the energy relaxation data may be inverted to yield energy relaxation rate data. The energy relaxation rate data may be plotted as a function of frequency and as a function of time.

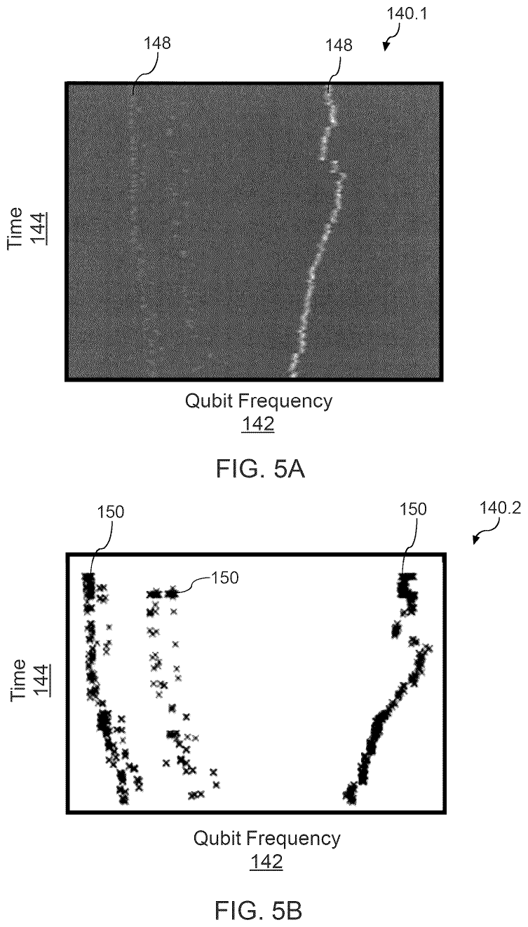

FIG. 5A depicts an example plot of characterization data 140.1 after undergoing pre-processing that includes inverting the characterization data. FIG. 5A plots qubit frequency 142 along the horizontal axis and time 144 along the vertical axis. The pixel values represent energy relaxation rate.

In some examples, pre-processing the characterization data may include threshold processing. Threshold processing may include identifying data points within the characterization data that exceed a defined threshold. These data points may be extracted and used for further processing (e.g., by an unsupervised learning operation). Other example pre-processing techniques may be used to extract certain data points without deviating from the scope of the present disclosure. For instance, one or more peak finding operations may be used to identify data points within the characterization data.

FIG. 5B depicts an example plot of characterization data 140.2 after undergoing threshold processing. FIG. 5B plots qubit frequency 142 along the horizontal axis and time 144 along the vertical axis. As illustrated, the characterization data 140.2 include data points 150 (in this example peaks of energy relaxation rate) that exceed a defined threshold.

Referring back to FIG. 4, the method 200 at 206 includes implementing an unsupervised learning operation to extract one or more anomalies (e.g., existing anomalies and/or predicted anomalies) from the characterization data. The unsupervised learning operation may be operable to cluster, pattern, and/or classify data points in the characterization data without requiring tagging or labeling of the data and without requiring training data.

In some examples, the unsupervised learning operation may be a clustering operation, such as any suitable clustering algorithm used to cluster data points. In some examples, the clustering operation may be a density-based clustering operation, such as a density-based spatial clustering of applications with noise (DBSCAN) algorithm. A density-based spatial clustering operation may be particularly robust to identifying the irregular and, in some examples, non-linearly separable anomalies. In some examples, the clustering operation may be a spectral-based clustering operation. Other unsupervised learning operations may be used, in some applications, without deviating from the scope of the present disclosure, such as k-means clustering operations (e.g., to identify circular anomalies), expectation-maximization operations (e.g., to identify elliptical anomalies), or other clustering operations.

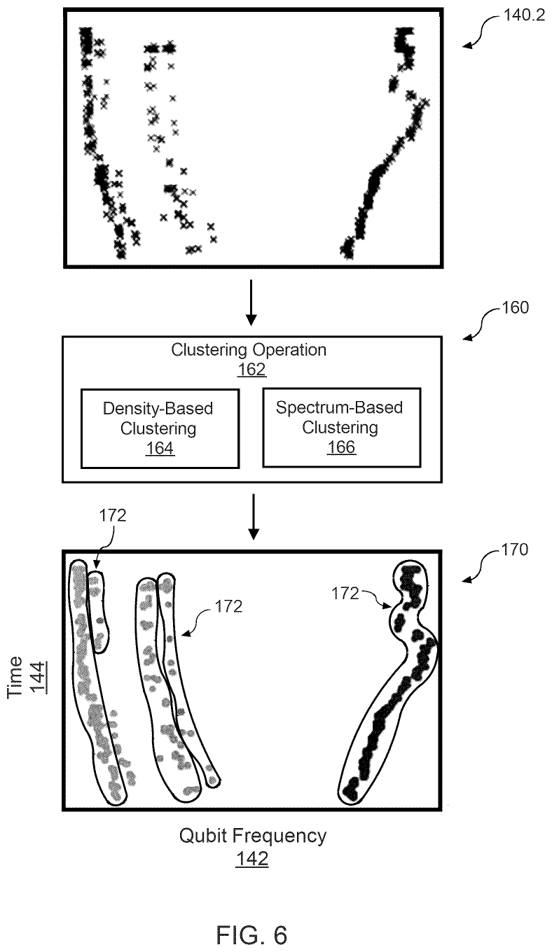

FIG. 6 depicts an example implementation of an unsupervised learning operation 160 on pre-processed characterization data 140.2 according to example aspects of the present disclosure. More particularly, pre-processed characterization data 140.2 is provided to the unsupervised learning operation 160. The unsupervised learning operation 160 may be a clustering operation 162. The clustering operation 162 may include a density-based clustering operation 164 and/or a spectral-based clustering operation 166. The unsupervised learning operation 160 may provide an output 170 which segments, groups, and/or classifies data points into clusters 172.

In some examples, an unsupervised learning operation may be operable to extract future predicted anomalies (e.g., predicted collisions with two-level-system defects). For instance, in some examples, after clustering of data points from the characterization data, a time dependence of the data may be fitted using a polynomial function (e.g., a quadratic polynomial function) or other suitable function. The polynomial function or other function may be extrapolated to future times to determine future predicted anomalies. Ranges of operating parameters where anomalies are likely to appear may be determined based at least in part on the future predicted anomalies.

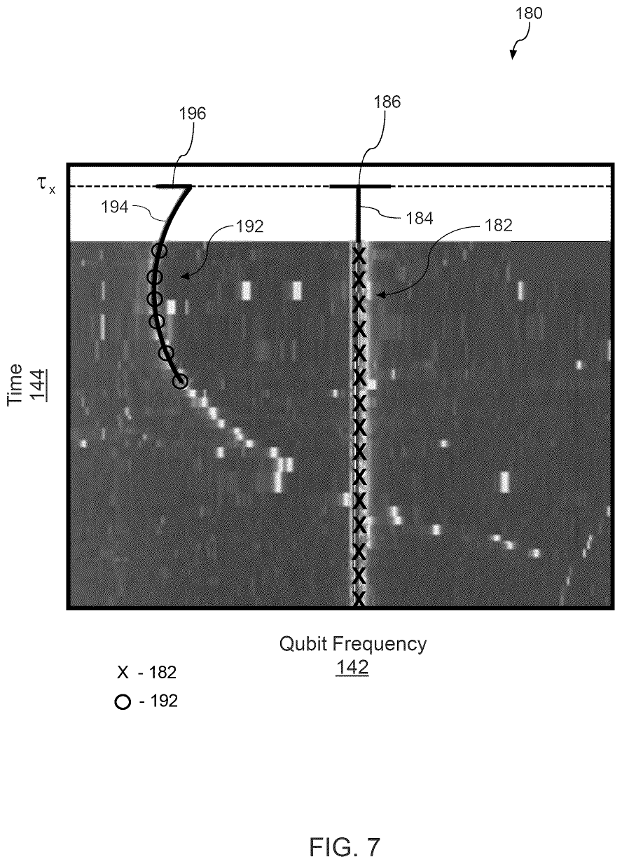

FIG. 7 depicts the example determination of future predicted anomalies according to example embodiments of the present disclosure. FIG. 7 depicts a plot of characterization data 180 after processing by a clustering operation. FIG. 7 plots qubit frequency 142 along the horizontal axis and time 144 along the vertical axis. The data points 182 represented by Xs may be associated with a first cluster identified using an unsupervised learning operation. The data points 192 represented by Os may be associated with a second cluster identified using an unsupervised learning operation. A function 184 may be fit to the data points 182. A function 194 may be fit to the data points 192. The function 184 may be extrapolated to future times to provide predicted future anomalies. The function 194 may be extrapolated to future time to provide predicted future anomalies.

Referring back to FIG. 4, the method 200 at 208 may include operating a qubit in the quantum computing system based at least in part on the one or more anomalies, such as the future predicted anomalies. For instance, one or more qubits in the quantum computing system may be calibrated and/or operated at an operating parameter that is selected to reduce the likelihood of coinciding with an anomaly, such as a future predicted anomaly.

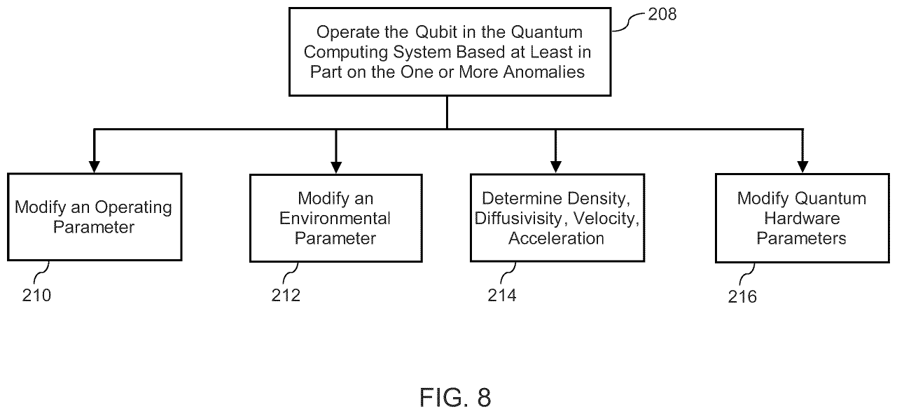

FIG. 8 depicts a flow diagram of different operations associated with operating a qubit in the quantum computing system based at least in part on the one or more anomalies according to example embodiments of the present disclosure. FIG. 8 depicts operations performed in a particular order for purposes of illustration and discussion. Those of ordinary skill in the art, using the disclosures provided herein, will understand that operations of any of the methods described herein may be expanded, include steps not illustrated, omitted, rearranged, and/or modified in various ways without deviating from the scope of the present disclosure.

At 210, operating the qubit in the quantum computing system 208 may include modifying an operating parameter (e.g., an operating frequency) of the qubit during calibration and/or implementation of a quantum operation, such as one or more quantum gates, state preparation, and/or measurement. The operating parameter may be modified based on the anomalies extracted from the unsupervised learning algorithm. For instance, in one example, the operating parameter may be modified to avoid the likelihood of coinciding with a future predicted anomaly.

For example, referring to FIG. 7, the operating frequency extrema of the fitted functions 184 and 194 may be used to identify an operating frequency range to avoid during operation of a qubit. One example operating frequency range for time tx may be represented by horizontal line 186 and 196 in FIG. 7. According to example embodiments, the operating frequency may be modified during operation to avoid the operating frequency ranges represented by horizontal lines 186 and 196 at a future time tx.

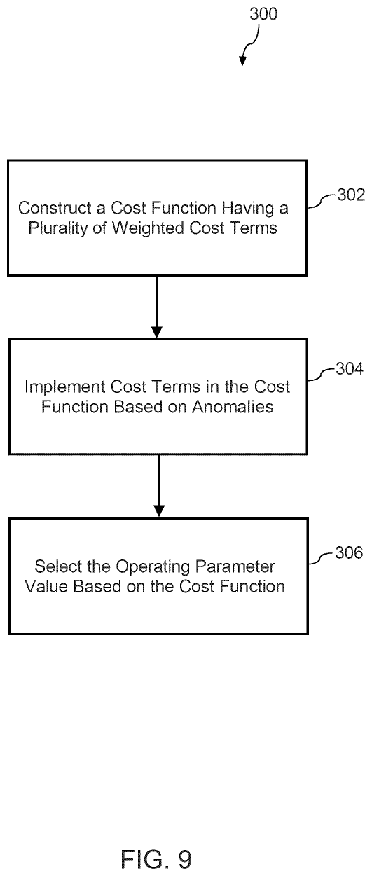

FIG. 9 depicts a flow diagram of an example method 300 for selecting and/or modifying an operating parameter based at least in part on the one or more anomalies. The method 300 may be implemented using any suitable quantum and/or classical computing systems, such as the system described in FIG. 1 and/or FIG. 10. FIG. 9 depicts operations performed in a particular order for purposes of illustration and discussion. Those of ordinary skill in the art, using the disclosures provided herein, will understand that operations of any of the methods described herein may be expanded, include steps not illustrated, omitted, rearranged, and/or modified in various ways without deviating from the scope of the present disclosure.

At 302, the method includes constructing a cost function having a plurality of weighted cost terms. The cost function may map qubit operating parameter values (e.g., operating frequency values) to a cost (e.g., a real number) corresponding to a state of the quantum device. A lower cost may correspond to a better operating state for the quantum device (e.g., implement a quantum algorithm with reduced error rate). The cost function may have a plurality of weighted cost terms. The cost function terms and weights may be determined, for instance, based at least in part on data representing properties of qubits included in the quantum computing device.

At 304, the method includes implementing cost terms in the cost function based on the one or more anomalies. For instance, at least one of the weighted cost terms in the cost function may be based at least in part on the one or more anomalies extracted using the unsupervised learning operation. In some examples, at least one of the weighted cost terms in the cost function may be based on a future predicted anomaly.

At 306, the method includes selecting an operating parameter value based on the cost function. For instance, an optimization process may be performed on the cost function to determine operating parameter values for one or more qubits.

Other suitable applications for anomaly detection may be used without deviating from the scope of the present disclosure. For instance, referring to FIG. 8 at 212, operating the qubit in the quantum computing system 208 may include modifying an environmental parameter associated with the quantum computing system. For instance, the one or more anomalies may be correlated with one or more environmental parameters associated with the operating environment of a quantum computing system. The environmental parameters may be indicative of external conditions associated with the environment in which the quantum computing system operates. Example environmental parameters may include operating temperature of the quantum hardware, vibration information, electromagnetic field, control electronics parameters, etc. Based on the correlation, one or more environmental parameters may be modified to reduce the likelihood of occurrence of an anomaly.

At 214, operating the qubit in the quantum computing system 208 may include analyzing the one or more anomalies to characterize one or more properties of the one or more anomalies. Example properties may include density, diffusivity, velocity, acceleration, etc. Density may refer to the density of the one or more anomalies in the operating parameter domain (e.g., operating frequency domain) or in the time domain. Diffusivity may provide a quantifiable measure indicative of the spread or distribution of the anomalies in the operating parameter domain or in the time domain. Velocity may refer to the rate and/or direction at which the anomaly moves in the operating parameter domain over time. Acceleration may refer to any change in rate and/or direction of the anomaly in the operating parameter domain over time. Other suitable properties of the one or more anomalies may be determined without deviating from the scope of the present disclosure.

At 216, operating the qubit in the quantum computing system 208 may include modifying a hardware parameter associated with the quantum computing system. For instance, the one or more anomalies may be correlated with one or more hardware parameters associated with the quantum computing system. Example hardware parameters may be associated with fabrication processes, materials for the qubits/quantum hardware, qubit design, quantum processor design, control electronics, etc. Based on the correlation, one or more hardware parameters may be modified to reduce the likelihood of occurrence of an anomaly.

FIG. 10 depicts a block diagram of an example computing system 400 that determines operating parameter values for one or qubits according to example embodiments of the present disclosure. The system 400 includes a user computing device 402, a server computing system 430, and a quantum computing system 490 that are communicatively coupled over a network 480.

The user computing device 402 may be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 402 includes one or more processors 412 and a memory 414. The one or more processors 412 may be any suitable processing device (e.g., a processor core, a microprocessor, an ASIC, an FPGA, a controller, a microcontroller, etc.) and may be one processor or a plurality of processors that are operatively connected. The memory 414 may include one or more non-transitory computer-readable storage media, such as RAM, ROM, EEPROM, EPROM, flash memory devices, magnetic disks, etc., and combinations thereof. The memory 414 may store data 416 and instructions 418 which are executed by the processor 412 to cause the user computing device 402 to perform operations, such as one or more of the operations of any of the methods provided herein.

In some implementations, the user computing device 402 may include instructions associated with an unsupervised learning operation 420. For example, the unsupervised learning operation 420 may be a clustering operation, such as any suitable clustering algorithm used to cluster data points. In some examples, the clustering operation may be a density-based clustering operation, such as a DBSCAN algorithm. In some examples, the clustering operation may be a spectral-based clustering operation. Other unsupervised learning operations may be used, in some applications, without deviating from the scope of the present disclosure, such as k-means clustering operations (e.g., to identify circular anomalies), expectation-maximization operations (e.g., to identify elliptical anomalies), or other clustering operations.

In some implementations, the unsupervised machine learning operation 420 may be received from the server computing system 430 over network 480, stored in the user computing device memory 414, and then used or otherwise implemented by the one or more processors 412.

Additionally, or alternatively, instructions associated with an unsupervised learning operation 440 may be included in or otherwise stored and implemented by the server computing system 430 that communicates with the user computing device 402 according to a client-server relationship. Thus, the unsupervised learning operation 420 may be stored and implemented at the user computing device 402 and/or the unsupervised learning operation 440 may be stored and implemented at the server computing system 430.

The user computing device 402 may also include one or more user input components 422 that receives user input. For example, the user input component 422 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, or other means by which a user may provide user input.

The server computing system 430 includes one or more processors 432 and a memory 434. The one or more processors 432 may be any suitable processing device (e.g., a processor core, a microprocessor, an ASIC, an FPGA, a controller, a microcontroller, etc.) and may be one processor or a plurality of processors that are operatively connected. The memory 434 may include one or more non-transitory computer-readable storage media, such as RAM, ROM, EEPROM, EPROM, flash memory devices, magnetic disks, etc., and combinations thereof. The memory 434 may store data 436 and instructions 438 which are executed by the processor 432 to cause the server computing system 430 to perform operations.

In some implementations, the server computing system 430 includes or is otherwise implemented by one or more server computing devices. In instances in which the server computing system 430 includes plural server computing devices, such server computing devices may operate according to sequential computing architectures, parallel computing architectures, or some combination thereof.

As described above, the server computing system 430 may store or otherwise include instructions associated with an unsupervised learning operation 440. For example, the unsupervised learning operation 440 may be a clustering operation, such as any suitable clustering algorithm used to cluster data points. In some examples, the clustering operation may be a density-based clustering operation, such as a DBSCAN algorithm. In some examples, the clustering operation may be a spectral-based clustering operation. Other unsupervised learning operations may be used, in some applications, without deviating from the scope of the present disclosure, such as k-means clustering operations (e.g., to identify circular anomalies), expectation-maximization operations (e.g., to identify elliptical anomalies), or other clustering operations.

The user computing device(s) 402 and/or the server computing system 430 may be in communication with the quantum computing system 490 including one or more qubits 492. The quantum computing system 490 may be the quantum computing system 100 depicted in FIG. 1 or other suitable quantum computing system. The quantum computing system 490 may provide characterization data associated with the qubit(s) 492 to the user computer device(s) 402 and/or the server computing system 430 for anomaly detection according to example embodiments of the present disclosure.

The network 480 may be any type of communications network, such as a local area network (e.g., intranet), wide area network (e.g., Internet), or some combination thereof and may include any number of wired or wireless links. In general, communication over the network 780 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Implementations of the digital, classical, and/or quantum subject matter and the digital functional operations and quantum operations described in this specification may be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification may be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium may be a machine-readable storage device, a machine-readable storage substrate, a random or serial access memory device, one or more qubits/qubit structures, or a combination of one or more of them. Alternatively or in addition, the program instructions may be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems may include atoms, electrons, photons, ions or superconducting qubits. In many implementations the computational basis states are identified with the ground and first excited states, however it is understood that other setups where the computational states are identified with higher level excited states (e.g., qudits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus may also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus may optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, may be written in any form of programming language, including compiled or interpreted languages, or declarative or procedural languages, and it may be deployed in any form, including as a stand-alone program or as a module, component, subroutine, or other unit suitable for use in a digital computing environment. A quantum computer program, which may also be referred to or described as a program, software, a software application, a module, a software module, a script, or code, may be written in any form of programming language, including compiled or interpreted languages, or declarative or procedural languages, and translated into a suitable quantum programming language, or may be written in a quantum programming language, e.g., QCL, Quipper, Cirq, etc.

A digital and/or quantum computer program may, but need not, correspond to a file in a file system. A program may be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program may be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification may be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows may also be performed by, and apparatus may also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program may be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory may be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that may store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, may be implemented in a digital and/or quantum computer program product that includes instructions that are stored on one or more tangible, non-transitory machine-readable storage media, and that are executable on one or more digital and/or quantum processing devices. The systems described in this specification, or portions of them, may each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations may also be implemented in combination in a single implementation. Conversely, various features that are described in the context of a single implementation may also be implemented in multiple implementations separately or in any suitable sub combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of operating a quantum computing system, the method comprising:
obtaining characterization data associated with an operating parameter of a qubit in a quantum computing system;
implementing an unsupervised learning operation to extract one or more anomalies from the characterization data; and
operating the qubit in the quantum computing system based at least in part on the one or more anomalies.

2. The method of claim 1, wherein the one or more anomalies comprise one or more future predicted anomalies.

3. The method of claim 1, wherein the qubit is a frequency tunable qubit, and the operating parameter comprises an operating frequency of the frequency tunable qubit.

4. The method of claim 1, wherein the characterization data comprises qubit energy relaxation time versus time.

5. The method of claim 1, wherein the one or more anomalies comprise one or more two-level-system defects.

6. The method of claim 1, wherein the unsupervised learning operation comprises a clustering operation.

7. The method of claim 6, wherein the clustering operation comprises a density-based clustering operation or a spectral-based clustering operation.

8. The method of claim 1, wherein the method comprises pre-processing the characterization data prior to implementation of the unsupervised learning operation.

9. The method of claim 8, wherein pre-processing the characterization data comprises inverting the characterization data.

10. The method of claim 8, wherein pre-processing the characterization data comprises extracting data points that exceed a defined threshold.

11. The method of claim 1, wherein operating the qubit in the quantum computing system based at least in part on the one or more anomalies comprises calibrating the qubit based at least in part on the one or more anomalies.

12. The method of claim 10, wherein calibrating the qubit comprises modifying an operating parameter associated with the qubit.

13. The method of claim 1, wherein operating the qubit in the quantum computing system based at least in part on the one or more anomalies comprises determining one or more of a density, diffusivity, velocity, or an acceleration associated with the one or more anomalies.

14. The method of claim 1, wherein operating the qubit in the quantum computing system based at least in part on the one or more anomalies comprises modifying one or more quantum hardware parameters based at least in part on the one or more anomalies.

15. The method of claim 1, wherein operating the qubit in the quantum computing system based at least in part on the one or more anomalies comprises modifying one or more environmental parameters based at least in part on the one or more anomalies.

16. A quantum computing system comprising:
a plurality of superconducting qubits, each qubit configured to be operated using an operating frequency, each operating frequency associated with an energy relaxation time;
one or more processors configured to execute computer-readable instructions stored in one or more memory devices to perform operations, the operations comprising:
obtaining characterization data associated with the energy relaxation time for each of the plurality of superconducting qubits at a plurality of possible operating frequencies;
implementing an unsupervised learning operation to extract one or more predicted collisions with two-level-system defects from the characterization data for each of the plurality of superconducting qubits; and
modifying an operating frequency for each of the plurality of superconducting qubits based at least in part on the one or more predicted collisions with two-level-system defects.

17. The quantum computing system of claim 16, wherein the unsupervised learning operation comprising a clustering operation.

18. The quantum computing system of claim 16, wherein implementing an unsupervised learning operation to extract one or more predicted collisions with two-level-system defects from the characterization data for each of the plurality of superconducting qubits comprises implementing the unsupervised learning operation to extract the one or more predicted collisions with two-level-system defects from the characterization data for each of the plurality of superconducting qubits in parallel.

19. The quantum computing system of claim 16, wherein the quantum computing system is configured to implement a quantum gate on one or more of the plurality of superconducting qubits based at least in part on the one or more predicted collisions with two-level-system defects.

20. A computer-readable storage medium comprising instructions that are executable by a classical or quantum processing device and upon such execution cause the classical or quantum processing device to perform operations comprising:
obtaining characterization data associated with an operating parameter of a qubit in a quantum computing system;
implementing an unsupervised learning operation to extract one or more predicted anomalies from the characterization data; and
modifying an operating parameter of the qubit in the quantum computing system based at least in part on the one or more predicted anomalies.
